(19) United States
(12) Patent Application Publication
(10) Pub. No.: US 2007/0221014 A1
(43) Pub. Date: Sep. 27, 2007

(54) BOTTLE OPENER RESEMBLING A DIVING LURE

(76) Inventor: Stephen W. Cruthirds, Redmond, OR (US)

Correspondence Address: Courtenay B. Allen;Cox Smith Matthews Incorporated, Suite 1800, 112 East Pecan Street, San Antonio, TX, 78205, US

(21) Appl. No.: 11/754,779

(22) Filed: May 29, 2007

Related U.S. Application Data
(63) Continuation of application No. 11/162,102, filed on Aug. 29, 2005.
Application No. 11/162,102 is a continuation of application No. 10/271,066, filed on Oct. 15, 2002, now Pat. No. 6,935,208.
(60) Provisional application No. 60/329,295, filed on Oct. 15, 2001.

(51) Int. Cl. B67B 7/16

(52) U.S. Cl. 81/3.55

(57) ABSTRACT

A bottle opener comprises a fish-shaped body with a loop-type bottle cap remover depending from the mouth of the fish-shaped body such that the bottle opener resembles a diving lure, which is particularly attractive to fishermen. Alternatively, the fish-shaped body may be provided with a bill and a lifting tab spaced apart from the bill. The fish-shaped body may have a gently curved dorsal surface that comfortably fits into the palm of a user's hand for easy grasping and use. To further resemble a diving lure, treble hooks or the like may be attached to the body. Such hooks may have rounded ends and no barbs in order to avoid punctures or cuts to the user. Conventional metal hooks may be dipped in a liquid plastic, rubber, or similar material that cures to form a resilient coating for safe handling.

### CROSS-REFERENCE TO RELATED APPLICATIONS

This application is a continuation of U.S. patent application Ser. No. 11/162,102, filed Aug. 29, 2005, which is a continuation of U.S. patent application Ser. No. 10/271,066 filed Oct. 15, 2002, which claims priority from U.S. Provisional Application Ser. No. 60/329,295 filed on Oct. 15, 2001.

### BACKGROUND

This application relates generally to an apparatus for opening bottled beverages, and more particularly to a bottle opener that resembles a diving lure used for fishing.

### SUMMARY

An embodiment of a bottle opener as disclosed herein may comprise a fish-shaped body with a loop-type bottle cap remover depending from the mouth of the fish-shaped body such that the bottle opener resembles a diving lure, which is particularly attractive to fishermen. Alternatively, instead of a loop-type bottle cap remover, another embodiment of a bottle opener may have a bill for engaging the top of a bottle cap and a lifting tab beneath the bill for engaging the lower edge of a bottle cap. The fish-shaped body may have a gently curved dorsal surface that comfortably fits into the palm of a user's hand for easy grasping and use. To further resemble a diving lure, treble hooks or the like may be attached to the fish-shaped body by conventional eyelets or other suitable attachment means. Such hooks may have rounded ends and no barbs in order to avoid punctures or cuts to the user. Conventional metal hooks may be dipped in a liquid plastic, rubber, or similar material that cures to form a resilient coating for safe handling.

### BRIEF DESCRIPTION OF THE DRAWINGS

FIG. 1 is a perspective view of a bottle opener.

FIG. 2 is a top view of the bottle opener of FIG. 1.

FIG. 3 is a left side view of the bottle opener of FIG. 1.

FIG. 4 is a right side view of the bottle opener of FIG. 1.

FIG. 5 is a bottom view of the bottle opener of FIG. 1.

FIG. 6 is a front view of the bottle opener of FIG. 1.

FIG. 7 is a rear view of the bottle opener of FIG. 1.

FIG. 8 is a perspective view of an alternative bottle opener.

FIG. 9 is a perspective view of another alternative bottle opener.

FIG. 10 is a left side view of the bottle opener of FIG. 9.

FIG. 11 is a bottom view of the bottle opener of FIG. 9.

### DETAILED DESCRIPTION

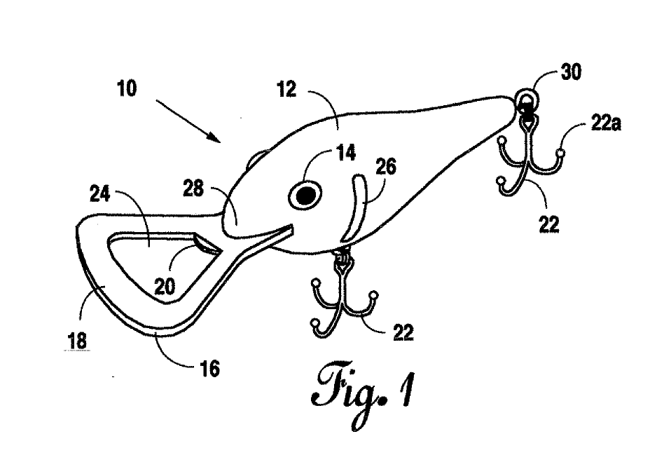

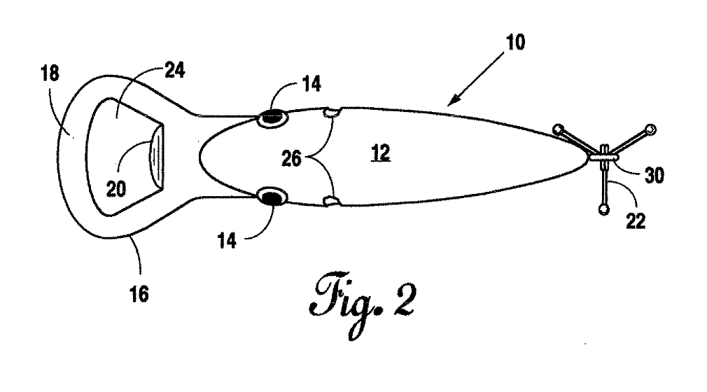

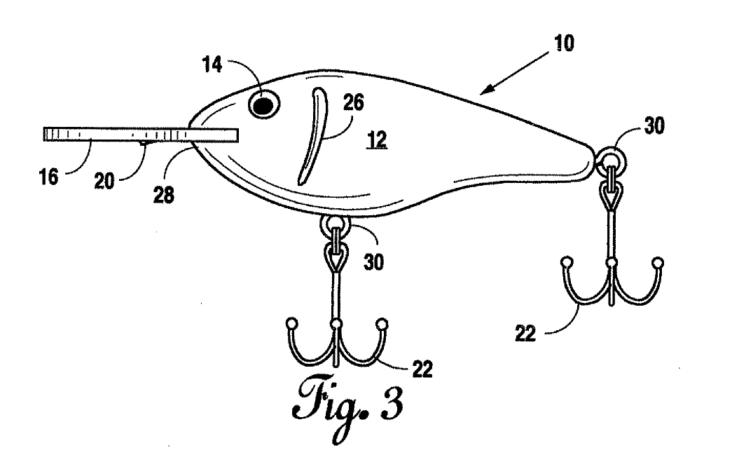

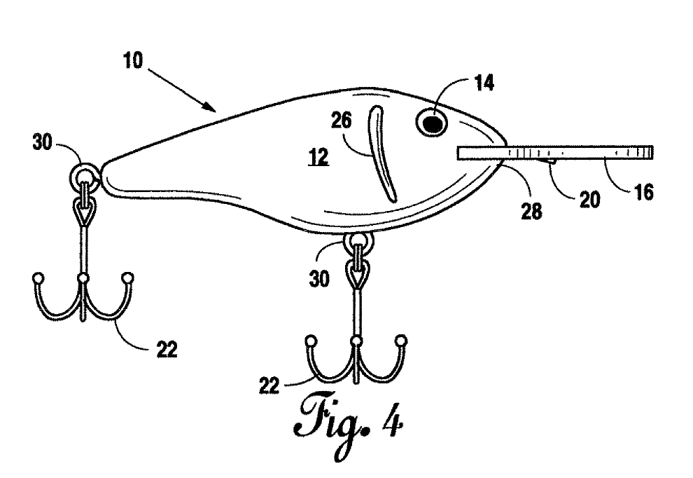

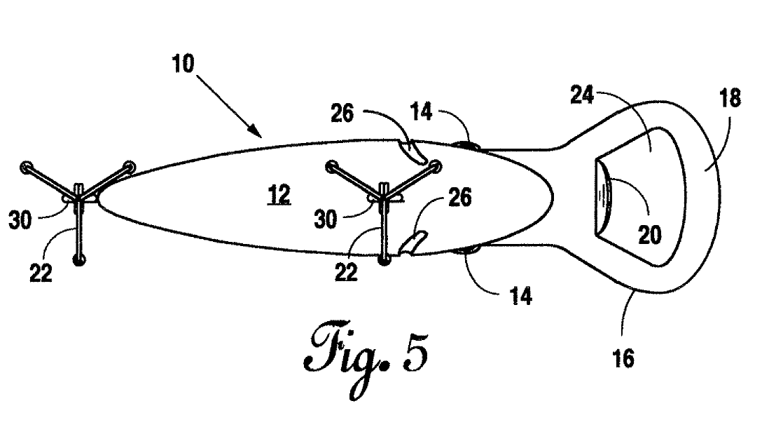

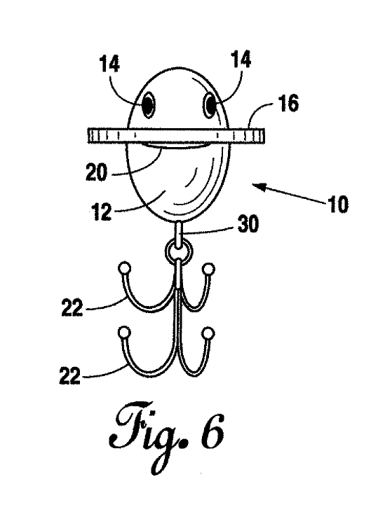

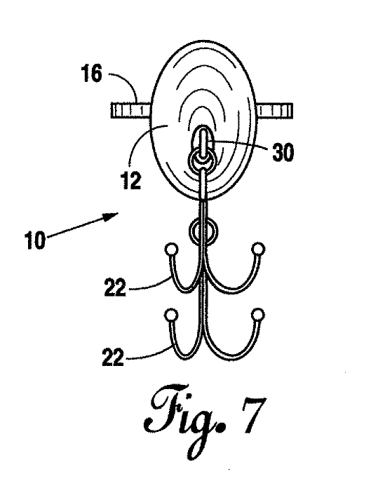

Referring to FIGS. 1-7, a bottle opener 10 may have a fish-shaped body 12 with a loop-type bottle cap remover 16 depending from the mouth 28 of the fish-shaped body 12 such that bottle opener 10 resembles a diving lure used for fishing. The fish-shaped body 12 may have a gently curved dorsal surface that comfortably fits into the palm of a user's hand for easy grasping and use. The fish-shaped body 12 may be molded from relatively rigid plastic, but it may be made of any other suitable material, such as metal, wood, fiberglass, or ceramic. Bottle cap remover 16 may be a conventional, metal, loop-type bottle cap remover fixedly mounted or embedded in mouth 28. Alternatively, bottle cap remover 16 may be integral with the fish-shaped body 12. Bottle cap remover 16 has a hole 24 bounded by a forward edge 18 and a rear tab 20, which is connected to forward edge 18 by a pair of sides to form a loop. Although bottle cap remover 16 may be made of metal, it may also be made of any other suitably stiff material. As shown in FIGS. 1, 3, 4, 6, and 7, bottle cap remover 16 may be generally flat except for tab 20, which may be angled slightly downward. As shown in FIGS. 1, 2, and 5, bottle cap remover 16 may have an outer shape comprising an arcuate and fairly broad forward edge 18 with sides that taper to about the same width as body 12 near mouth 28. However, the shape of bottle cap remover 16 and hole 24 may vary as desired. Bottle cap remover 16 is positionable about a bottle cap on a beverage bottle (not shown) such that forward edge 18 engages the top of the bottle cap and tab 20 engages the bottom edge of the bottle cap. By applying an upward force on body 12 and thereby lifting the rear end of bottle cap remover 16, the bottle cap may be removed from the bottle. Bottle opener 10 may have eyes 14 and indentations or protrusions 26 resembling gills positioned on body 12. Other indicia of fish, such as fins (not shown), may also be provided. Additionally, bottle opener 10 may have one or more hooks 22, such as conventional treble hooks, mounted on body 12 with eyelets 30 or other suitable attachment means so that bottle opener 10 further resembles a fishing lure. Hooks 22 may have rounded ends 22a and no barbs so as to avoid cutting and puncture hazards. Hooks 22 may be conventional metal hooks that are dipped in a liquid plastic, rubber, or similar material that cures to form a resilient protective coating (not shown) to cover and smooth over any sharp or pointed protrusions for safe handling. Hooks 22 may also be made of other nonmetal material, such as plastic.

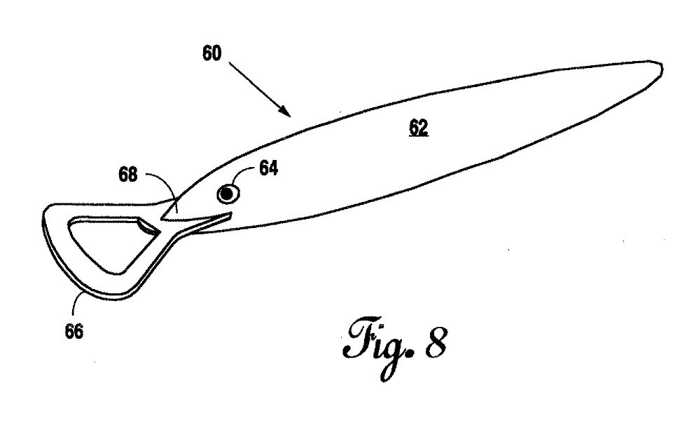

Alternatively, as shown in FIG. 8, an alternative bottle opener 60 may not have any hooks for the sake of simplicity and added safety. Like bottle opener 10 described above, bottle opener 60 has a fish-shaped body 62 with eyes 64 and a loop-type bottle cap remover 66 depending from mouth 68. It will be apparent to those skilled in the art that the size and shape of the fish-shaped body of a bottle opener as disclosed herein may vary considerably.

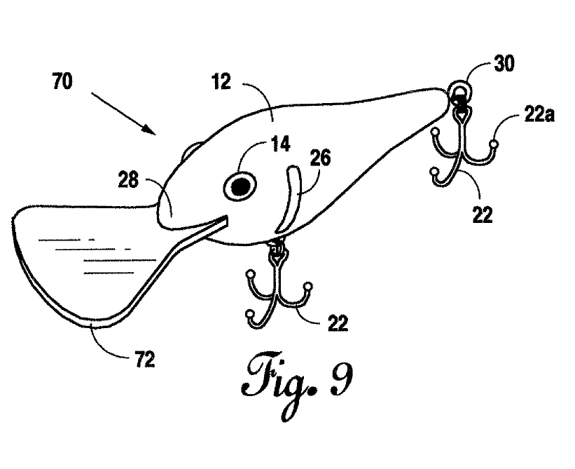

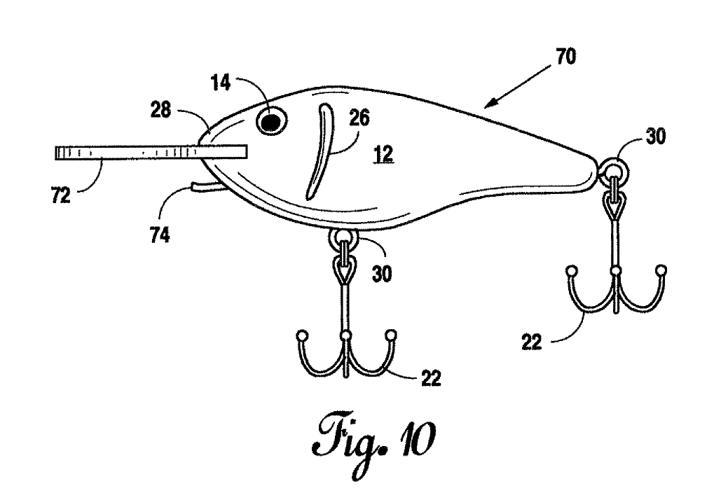

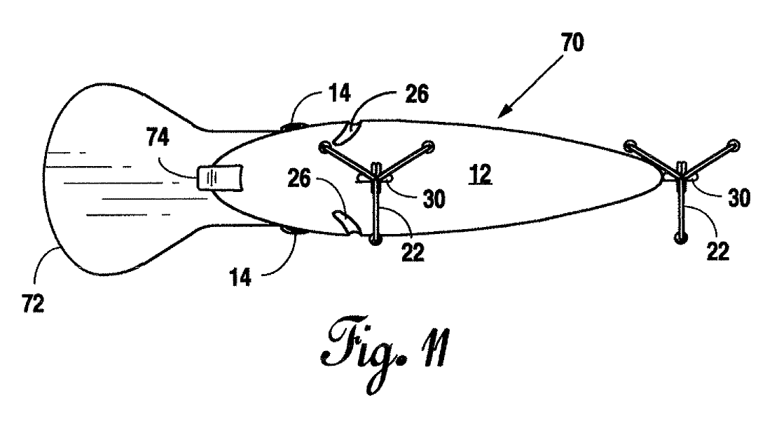

Referring to FIGS. 9-11, another alternative bottle opener 70 is shown having a fish-shaped body 12. Rather than a loop-type bottle cap remover, bottle opener 70 has a bill 72 depending from the mouth 28 of the fish-shaped body 12 such that bottle opener 70 resembles a diving lure used for fishing. For simplicity, bill 72 is illustrated as being generally planar, but bill 72 may have curvature if desired. A lifting tab 74 extends from body 12 in space relation to bill 72. Bill 72 and lifting tab 74, which form a bottle cap remover, are relatively rigid and are fixedly attached to or embedded in body 12. Alternatively, bill 72 and lifting tab 74 may be integral to body 12. Bill 72 and lifting tab 74 may be made of metal but may also be made of other suitably stiff material. Bottle opener 70 is positionable about a bottle cap on a beverage bottle (not shown) such that bill 72 engages the top of the bottle cap and lifting tab 74 engages the bottom edge of the bottle cap. When bottle opener 70 is so positioned about the bottle cap, applying an upward force on body 12 causes the bottle cap to be removed from the bottle. Bottle opener 70 may have eyes 14, indentations or protrusions 26 resembling gills, and hooks 22 connected to body 12 with eyelets 30 as discussed above in connection with bottle opener 10. The outer shape of bill 72 may be similar to that of bottle cap remover 16 as described above such that bottle opener 70 resembles a diving type fishing lure.

Although the foregoing specific details describe certain embodiments of this invention, persons reasonably skilled in the art will recognize that various changes may be made in the details of this invention without departing from the spirit and scope of the invention as defined in the appended claims. Therefore, it should be understood that this invention is not to be limited to the specific details shown and described herein.

1. A bottle opener comprising:
a fish-shaped body having a mouth; and
a loop-type bottle cap remover depending from said mouth.

2. The bottle opener of claim 1 wherein said bottle cap remover is fixedly mounted in said mouth.

3. The bottle opener of claim 1 wherein said bottle cap remover is integral with said body.

4. The bottle opener of claim 1 wherein said bottle cap remover is generally flat and comprises a hole bounded by an arcuate forward edge having a first width, a rear tab having a second width which is smaller than said first width, and tapered sides connecting said forward edge to said rear tab.

5. The bottle opener of claim 4 wherein said second width is approximately equal to the width of said body adjacent said mouth.

6. The bottle opener of claim 4 wherein said rear tab is angled downward.

7. A bottle opener comprising:
a fish-shaped body having a mouth;
a bill extending from said mouth; and
a lifting tab extending from said body in spaced relation to said bill.

8. The bottle opener of claim 7 wherein said bill and said lifting tab are fixedly mounted to said body.

9. The bottle opener of claim 7 wherein said bill and said lifting tab are integral with said body.

10. A bottle opener comprising:
a body; and
a bottle cap remover extending from said body;
wherein said body and said bottle cap remover are configured to resemble a diving type fishing lure.

11. The bottle opener of claim 10 wherein said bottle cap remover comprises a loop-type bottle cap remover.

12. The bottler opener of claim 10 wherein said bottle cap remover comprises a bill and a lifting tab in spaced relation to said bill.

13. The bottle opener of claim 10 further comprising at least one hook extending from said body.

14. A bottle opener comprising:
a lure-shaped body; and
a bill-shaped protrusion extending from said body; said protrusion having an opening therein; said opening being sized and shaped such that said protrusion is positionable about a bottle cap such that a first portion of said protrusion is engageable with a top portion of the bottle cap and a second portion of said protrusion is engageable with a bottom portion of the bottle cap.
